(19) United States
(12) Patent Application Publication
(10) Pub. No.: US 2003/0118699 A1
(43) Pub. Date: Jun. 26, 2003

(54) Edible candy makeup

(76) Inventor: Davide Nicosia, New York, NY (US)

Correspondence Address: Richard C. Litman, LITMAN LAW OFFICES, LTD., P.O. Box 15035, Arlington, VA, 22215, US

(21) Appl. No.: 10/023,770

(22) Filed: Dec. 21, 2001

(51) Int. Cl. A23G 1/00

(52) U.S. Cl. 426/104

(57) ABSTRACT

An edible sugar candy makeup composition made in various flavors, colors and configurations either a homogeneous body or coated with either edible colored lipstick, colored lip balm, and the like for application initially for the lips or the body. The candy can include vitamins, breath fresheners, chocolate, fruit and berry flavors, etc.

### BACKGROUND OF THE INVENTION

1. Field of the Invention

The present invention relates generally to candies and cosmetics. More specifically, the invention is edible candy in various flavors, colors and configurations coated with edible lipstick, lip balm or similar products for application initially to the lips or the body. The candy can include vitamins, a breath freshener, chocolate, fruit flavors, berry flavors, etc.

2. Description of the Related Art

The related art of interest describes various foods in various shapes containing various additives, but none discloses the present invention. There is a need for a product which can appeal to children and adults for providing cosmetic, medicinal and the like utility. The related art will be discussed in the order of perceived relevance to the present invention.

U.S. Pat. No. 4,251,561 issued on Feb. 17, 1981, to Robert J. Gajewski describes a method of preparing low-moisture, frangible aerated confections and the products thereof which are useful as blackboard chalks. The confections comprise about 87% to 99% dextrose, about 0.5% to 3% whipping agent, i.e., gelatin, caseinate, whey, soy protein with pepsin, and about 0.5% to 7% moisture (water). Optional ingredients from about 0.1% to 1.5% include flavors (cocoa), dyes, coloring agents, vitamins, preservatives and the like. Conventional milk-based confections such as non-fat milk solids are to be avoided because they interfere with the provision of a highly frangible confection. The confections are distinguishable for being limited to blackboard chalk sticks of 1 to 3 centimeters in cross-section.

U.S. Pat. No. 4,873,085 issued on Oct. 10, 1989, to Richard C. Fuisz describes a spun fibrous cosmetic sugar formed by melt spinning into a fiber form and compacting into individual dosage units or tablets for topical application. When lactose or maltose is used, they absorb moisture from the air and transfers the moisture to the hair and skin to maintain their moisture content. Sucrose is not used because it is not stable in fiber form. The preferred components are 90% mannitol, 5% sucrose and 5% mucopolysaccharide by weight and contain biotin and/or nicotinamide, a sun screen or a hair conditioner. The products are packaged in a sealed vial, which is opened and water added to a fill mark for use. The products are distinguishable for their required compacted fibrous sugar units useful as sun screen or a hair conditioner.

U.K. Patent Application No. 6972 published on Jun. 8, 1885, for Charles Wells describes confectionery jewelry in the form of necklaces and pendants. The products are distinguishable for being jewelry to be worn on the person for display.

U.S. Pat. No. 5,876,995 issued on Mar. 2, 1999, to Bruce Bryan describes bioluminescent novelty items such as toys, paints, slimy play material, clothing textiles, bubble making toys, bath powders, body lotions, gels, powders, creams toothpastes, soaps, body paints, bubble bath; foods such as gelatins, icings and frostings; beverages such as beer, wine, champagne, soft drinks; and glowing ice and fountains, toy cigarettes, fish food, jewelry, inter alia. The articles of manufacture are distinguishable for requiring bioluminescent material.

U.S. Pat. No. 2,018,934 issued on Oct. 29, 1935, to Alfred H. Vogel describes a display holder comprising a sheet of soft flexible material such as soft paper or a woven textile fabric of high capillarity having adhered on one face of the sheet sugar ornaments. The product is distinguishable for being limited to a sheet of edible sugar ornaments.

U.S. Pat. No. 4,136,163 issued on Jan. 23, 1979, to Hugh R. Watson et al. describes N-substituted-p-menthane-3-carboxamides having a property of stimulating the cold receptors of the nervous system of the human body to produce a cold sensation. These substances are added to a variety of edible and topical preparations. The cold receptor stimulating compounds are distinguishable for being limited to their special sensation producing capacity.

U.S. Design Pat. No. 359,608 issued on Jun. 27, 1995, for Aaron A. Allen describes a candy simulated microphone having indicia on its handle. The article is distinguishable for its microphone structure.

Netherlands Pat. Application No. 8403182A published on May 16, 1986, for A. Hoogeveen describes an edible crayon comprising an edible casing filled with a colored filling for decorating cakes or for use by children. The product is distinguishable for its structure of a casing containing an edible filling.

Japan Pat. Application No. 59-63150 published on Jan. 4, 1984, for Y. Tamura describes an unpolished rice cake in the form of apertured discs with an indented pattern strung on a string. The indentations allow seasoning to be adhered to the rice cake. The product can be seasoned on its surface and can be made of rice and flour. The product is distinguishable for being a novelty item for rice candy lovers.

European Pat. Application No. 0 435 556 A1 published on Jul. 3, 1991, for Maremitsu Izumitani describes beautifying compositions comprising tannins and vitamins added to a food or a drink such as candy, coffee, chocolate, tea, gum, cookie, cereal, wine, fruit juice, carbonated beverage, and jam. The compositions are distinguishable for requiring a bleaching reagent such as tannins to the food.

None of the above inventions and patents, taken either singularly or in combination, is seen to describe the instant invention as claimed. Thus, a edible candy makeup solving the aforementioned problems is desired.

### SUMMARY OF THE INVENTION

The present invention is an edible candy made in various flavors, colors and configurations coated with edible lipstick, lip balm, and the like for application initially for the lips or the body. The candy can include vitamins, breath fresheners, vanilla, chocolate, fruit flavors, etc. The candy can have embossed indicia such as words and flowers on circular, triangular, oval, star, heart, rod and the like tablet shapes.

Accordingly, it is a principal object of the invention to provide a shaped confection coated with a cosmetic.

It is another object of the invention to provide a shaped confection having various flavors, colors and shapes.

It is a further object of the invention to provide a confection coated with edible lipstick or lip balm.

Still another object of the invention is to provide a confection containing either vitamins, breath fresheners, fruit flavors, vanilla or chocolate.

Yet still another object of the invention is to provide a confection having embossed indicia such as words or flowers.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of an edible candy makeup composition being used to apply lipstick to the lips according to the present invention.

FIG. 2 is a perspective view of a first embodiment of a star-shaped candy having a lipstick coating and embossed with “PEACE”.

FIG. 3 is a perspective view of a second embodiment of a disc-shaped candy having a lipstick coating and embossed with “HOPE”.

FIG. 4 is a perspective view of a third embodiment of an oval-shaped mint candy having a lipstick coating and embossed with a flower.

FIG. 5 is a perspective view of a fourth embodiment of a heart-shaped candy having a lipstick coating and embossed with “LOVE”.

FIG. 6 is a perspective view of a fifth embodiment of the lipstick-coated products in a transparent package for individual use.

Similar reference characters denote corresponding features consistently throughout the attached drawings.

### DETAILED DESCRIPTION OF THE PREFERRED EMBODIMENTS

The present invention is directed to multiple use, scented, colored, and variously shaped novelty candies to be used by both adults and children. The candy can be any edible confectionery composition and chewing gum. Powdered sugar (sucrose) is preferred, but citric acid and/or corn syrup can be added. The flavoring can be any popular flavor such as spearmint, peppermint, licorice, lemon, orange, strawberry, raspberry, cherry, and the like. The coloring can be the natural coloring of the flavoring additive or any added conventional food coloring. The coloring can be monotone or contrasting. The novelty candy can be embossed with indicia such as words and ornamental designs such as flowers and the like. The lipstick coated confection compositions can have various shapes as illustrated by the examples. The shaping of the bodies can be performed by hand using cookie making cutouts or by molding machinery.

However, the most significant aspect of the invention is the coating of a colored edible lipstick on the novelty candy or a homogenous lipstick candy for decorating the lips, face and body for daily use or for celebrations such as birthdays and holidays. The lipstick can contain artificial gold dust (pulverized pyrite or Fool's Gold).

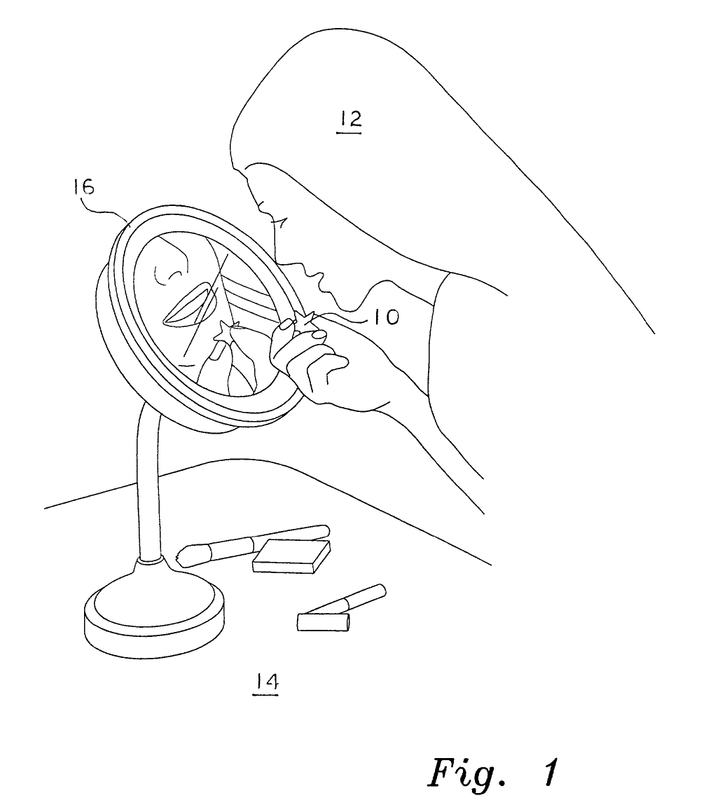

FIG. 1 illustrates a lipstick or lip balm having the form of either a homogeneous or coated star confection composition 10 being used by a woman 12 at her vanity table 14 while looking into a mirror 16.

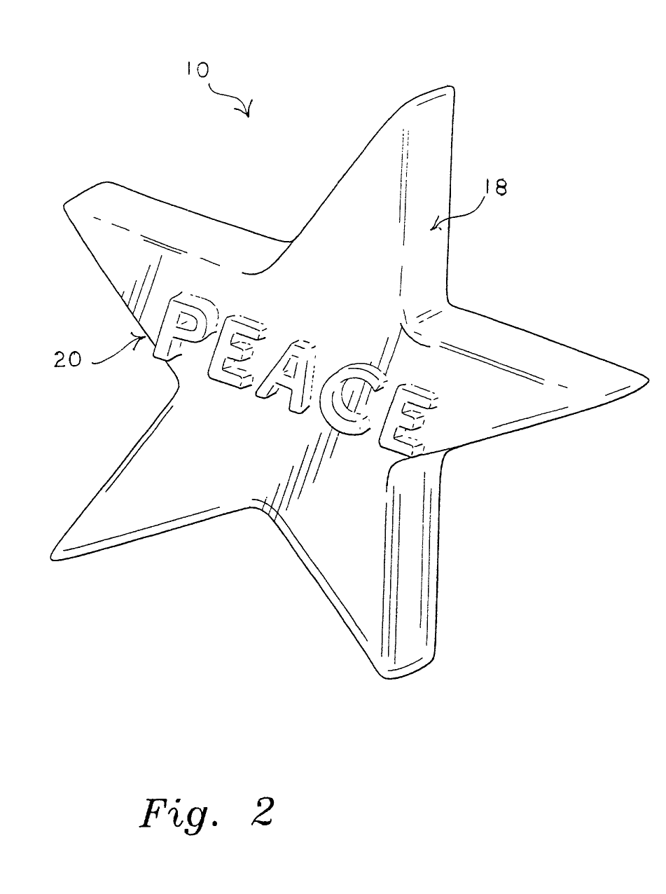

FIG. 2 depicts the lipstick or lip balm either homogeneous or coated, five-point star confection composition 10 as a first embodiment containing an edible lipstick or lip balm 18 having a clear or luminous gloss or any conventional coloring, and embossed with “PEACE” 20 on both planar surfaces. The words and the substrate can have contrasting colors based on the coloring of the coating 18. The lipstick of the composition 10 as well as the other compositions can be applied to one's face or body as a decoration or statement, and the lipstick can be eaten to provide oneself with vitamins, a breath freshener, or relished as a chocolate, vanilla or fruit-flavored candy.

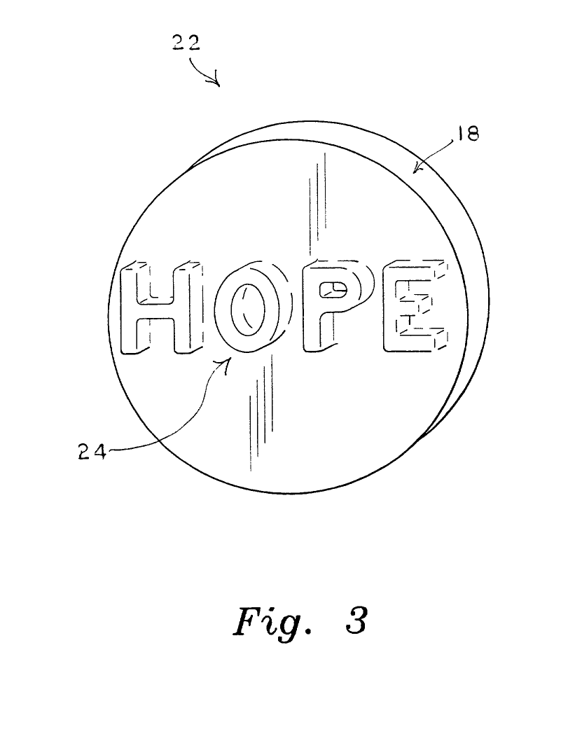

FIG. 3 shows as a second embodiment a circular tablet composition 22, either homogeneous or covered entirely, with a similar edible lipstick or lip balm coating 18 and having “HOPE” 24 embossed on both planar surfaces.

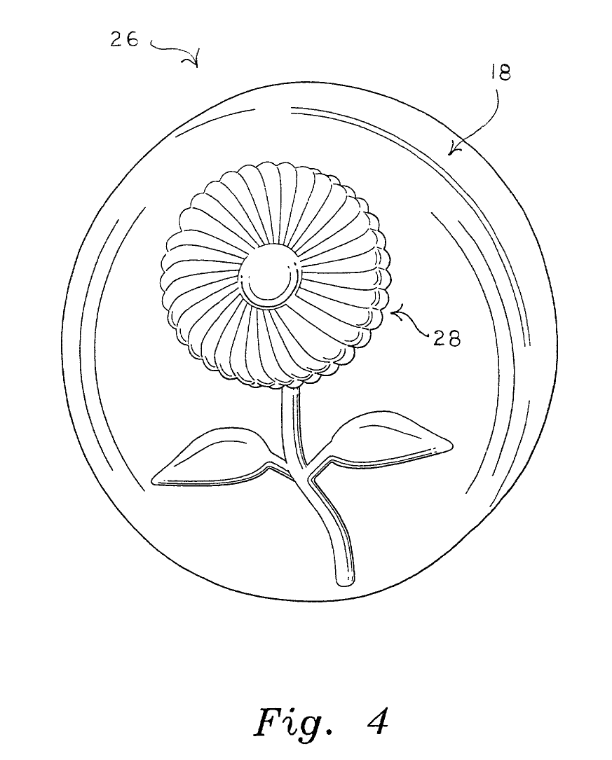

FIG. 4 illustrates as a third embodiment a circular tablet composition 26, either homogenous or covered completely, with a similar edible lipstick coating or lip balm 18 and having a flower 28 embossed on both planar surfaces.

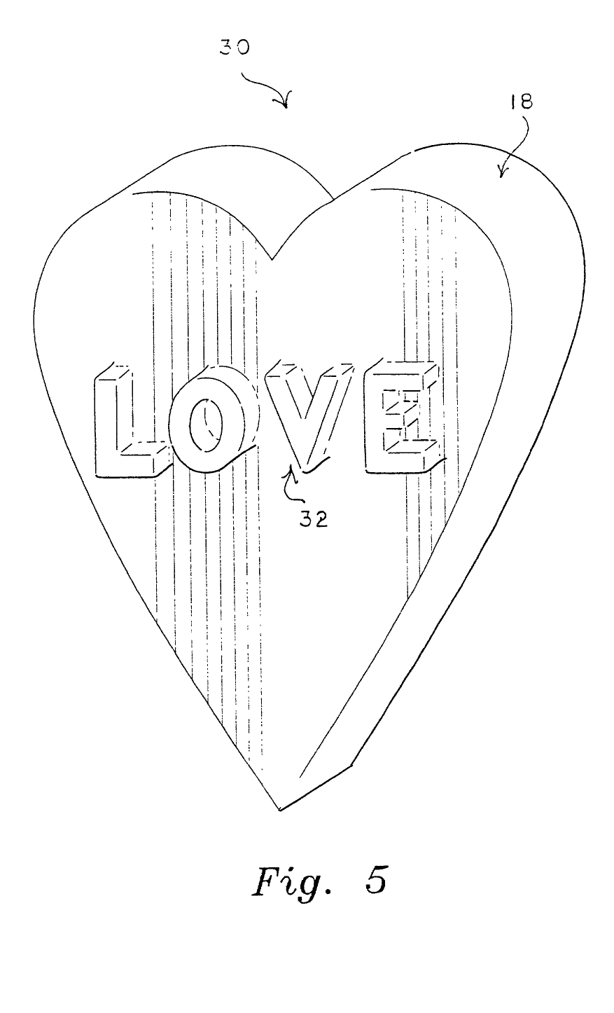

FIG. 5 shows as a fourth embodiment a heart-shaped tablet composition 30, either homogeneous or covered entirely, with a similar edible lipstick or lip balm coating 18 and having “LOVE” 32 embossed on both planar surfaces. Other words such as names, places and the like can be embossed.

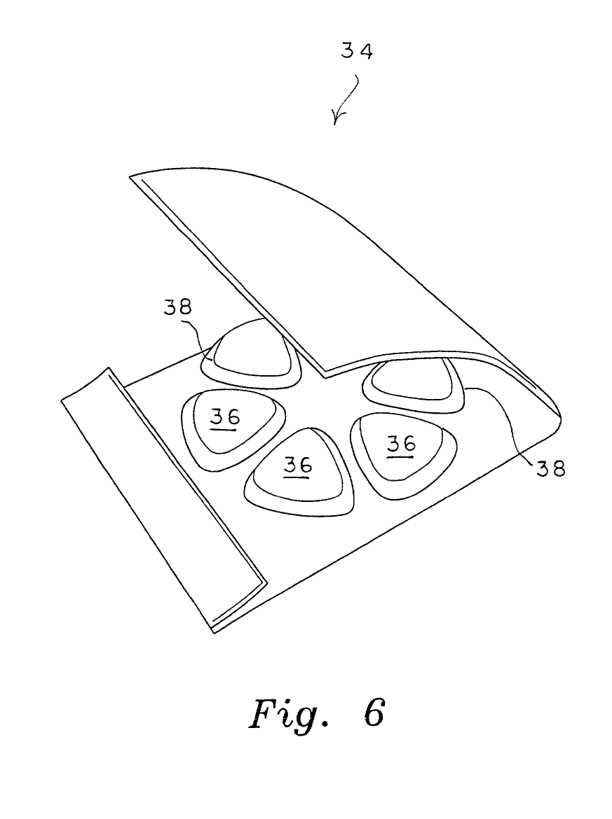

FIG. 6 depicts as a fifth embodiment a package 34 in the form of a larger matchbook containing five triangular shaped and edible, either homogeneous or coated, lipstick tablets 36 under a thin transparent plastic or glassine cover 38. Other shapes such as a square, a rectangle, an oval, a cylindrical rod and the like are contemplated. This sophisticated packaging would appeal to teen-age children as well as adults. Individual packaging is also contemplated either in single transparent packages or in the form of a string of tablets which can be torn off one at a time for use.

Thus, a variety of edible lipstick or lip balm covered or homogeneous edible candies in various configurations and packaging can be provided for everyone from children to adults containing various colors and ingredients such as vitamins and breath fresheners, and flavors such as chocolate, vanilla, strawberry, blackberry, blueberry, raspberry, lemon, orange, pineapple, and the like.

The following two examples demonstrate the preparation of the present invention for a candy lipstick tablet, designated composition A and composition B below, using the combining proportions in grams and in percentage by weight. Vitamins and breath fresheners were omitted from these examples.

| | Weight in grams | Percentage |
|---|---|---|
| Composition A: | | |
| Dipac sugar | 300.00 | 97.86 |
| Citric acid | 1.00 | 0.33 |
| Blue, No. 1 Lake | 0.07 | 0.02 |
| Red Dye, No. 40 | 1.00 | 0.33 |
| Nat. Tripleberry F1.7181, Ottens | 1.50 | 0.49 |
| Magnesium stearate | 3.00 | 0.98 |
| Total | 306.57 | 100.00 |
| Composition B: | | |
| Unidex dextrose | 300.00 | 96.74 |
| Citric acid | 3.00 | 0.97 |
| Blue No. 1 Lake | 0.12 | 0.04 |
| Blue dye No. 1 | 1.00 | 0.32 |
| N & A Mixed Berry No. 5842, Ottens | 3.00 | 0.97 |
| Magnesium stearate | 3.00 | 0.97 |
| Total | 310.12 | 100.00 |

The above lipstick candy ingredients were mixed as follows: Dry mix the sugar or dextrose with dye, lake colors, and citric acid until well blended. Add the flavors and mix until well blended. Add the magnesium stearate and mix for a minute. Run the mixture through a tablet press for desired size and hardness.

If a lipstick coated tablet, et cetera. is desired, the tablets, rods and the like can be prepared with any candy base such as chocolate in any shape such as stars, embossed pieces and the like, having a coating of the above specified or disclosed compositions.

It is to be understood that the present invention is not limited to the embodiments described above, but encompasses any and all embodiments within the scope of the following claims.

I claim:

1. An edible candy makeup composition comprising:
an edible sugar candy composition having either a homogeneous edible body or a thin edible coating suitable on an edible base for make-up and imprinting indicia; and
said edible sugar candy having a specific, predetermined configuration;
whereby a person can apply make-up or imprint indicia on various parts of a human body.

2. The edible candy makeup composition according to claim 1, wherein the edible body or coating is selected from the group consisting of lipstick and lip balm.

3. The edible candy makeup composition according to claim 1, wherein the edible body or coating has a color selected from an array of food coloring agents.

4. The edible candy makeup composition according to claim 1, wherein the edible body or coating has a color selected from the group consisting of artificial gold dust and luminescent color.

5. The edible candy makeup composition according to claim 1, wherein the edible body or coating composition contains a flavor selected from the group consisting of spearmint, peppermint, vanilla, strawberry, blackberry, blueberry, orange, lemon, and chocolate.

6. The edible candy makeup composition according to claim 1, wherein the edible body or coating composition contains at least one vitamin.

7. The edible candy makeup composition according to claim 1, wherein the composition is a coated chewable gum.

8. The edible candy makeup composition according to claim 1, wherein the composition is made in various tablet body shapes selected from the group consisting of circles, triangles, squares, rectangles, ovals, hearts, and stars.

9. The edible candy makeup composition according to claim 1, wherein the composition body is embossed with indicia selected from the group consisting of words or decorations and colored with contrasting colors.

10. The edible candy makeup composition according to claim 1, wherein the composition body is individually wrapped or wrapped in a string of a transparent package.

11. The edible candy makeup composition according to claim 1, wherein a plurality of composition bodies are wrapped individually in a matchbook shaped package under a transparent cover.
